(19) United States
(12) Patent Application Publication
(10) Pub. No.: US 2002/0101191 A1
(43) Pub. Date: Aug. 1, 2002

(54) Sealed microwave lamp and light distribution system

(76) Inventors: James T. Dolan, Frederick, MD (US); Kent Kipling, Gaithersburg, MD (US); Michael Dubinovsky, Pembroke Pines, FL (US)

Correspondence Address: FUSION LIGHTING INC, PAUL E STEINER, 7524 STANDISH PLACE, ROCKVILLE, MD, 20855

(21) Appl. No.: 09/986,971

(22) Filed: Nov. 13, 2001

Related U.S. Application Data
(60) Provisional application No. 60/247,034, filed on Nov. 13, 2000.
(60) Provisional application No. 60/299,753, filed on Jun. 22, 2001.
(60) Provisional application No. 60/308,134, filed on Jul. 30, 2001.

(51) Int. Cl. H05B 41/16

(52) U.S. Cl. 315/248

(57) ABSTRACT

An electrodeless microwave discharge lamp includes a substantially sealed microwave cavity, an envelope disposed within the sealed cavity, the envelope containing a fill which emits light when excited by microwave energy, and means for circulating air inside the sealed microwave cavity. For example, the means for circulating air includes a ceramic reflector inside the cavity with defined air flow channels. The lamp may further include a fan for moving air through the defined air flow channels. For example, the envelope is adapted to rotate during operation and blades are mounted on the stem of the bulb inside the sealed cavity. A sealed light distribution system includes a hollow light pipe having an opening at one end and an annular ring of elastomeric material secured to the open end of the light pipe. When used with a lamp with a reflector, the reflector is received in the opening of the ring and the ring forms a seal around the outside of the reflector. Another light distribution system includes a multi layer light conduit having at least two full layers formed by a single spiral wound plastic sheet. Another light distribution system includes a reflector positioned to receive light from a light source to transform at least some of the light into shallow angle light relative to a light emitting wall of an enclosure. The light is distributed through the enclosure by specular reflection of the shallow angle light.

Certain inventions described herein were made with Government support under Contract Nos. DE-FC26-00NT40988 or DE-FC-99FT40635 awarded by the Department of Energy. The Government has certain rights in those inventions.

### BACKGROUND

1. Field of the Invention

The invention relates generally to electrodeless microwave discharge lamps and light pipes. More particularly, the invention relates to cooling of sealed microwave discharge lamps, a sealed light pipe, and a spiral wound light pipe.

2. Related Art

In general, the present invention relates to the type of lamps described in PCT Publication No. WO/70651, which is herein incorporated by reference in its entirety. U.S. Pat. No. 5,998,934 describes an electrodeless microwave discharge lamp which includes a blow guide inside the microwave cavity for concentrating air flow over the bulb.

### SUMMARY

In general, the invention described herein is related to the lamps described in the above-referenced '651 publication, and to various improvements and/or modifications thereof. A detailed discussion of such lamps and the manner of making and using such lamps is incorporated herein by reference to that application.

High brightness microwave lamps may be effectively utilized by lighting distribution systems such as the light pipe systems described in PCT Publication No. WO 00/43815, for example. These lamps may also be effectively utilized in light pipe systems which use optical lighting film (OLF).

As noted in the '651 publication, in some situations it may be desirable to seal the microwave cavity of a discharge lamp from external contaminants. Air from the environment outside of the lamp may contain dirt, water, or other matter which could negatively affect the lamp performance. One object of the present invention is to provide a sealed microwave discharge lamp with forced air cooling using only air within the sealed volume.

According to one aspect of the invention, an electrodeless microwave discharge lamp includes a substantially sealed microwave cavity, an envelope disposed within the sealed cavity, the envelope containing a fill which emits light when excited by microwave energy, and means for circulating air inside the sealed microwave cavity. For example, the means for circulating air includes a ceramic reflector inside the cavity with defined air flow channels. The lamp may further include a fan for moving air through the defined air flow channels. For example, the envelope is adapted to rotate during operation and blades are mounted on the stem of the bulb inside the sealed cavity. According to another aspect of the invention a sealed light distribution system includes a hollow light pipe having an opening at one end and an annular ring of elastomeric material secured to the open end of the light pipe. When used with a lamp with a reflector, the reflector is received in the opening of the ring and the ring forms a seal around the outside of the reflector. According to another aspect of the invention, a light distribution system includes a multi layer light conduit having at least two full layers formed by a single spiral wound plastic sheet. According to another aspect of the invention, a light distribution system includes a reflector positioned to receive light from a light source to transform at least some of the light into shallow angle light relative to a light emitting wall of an enclosure. The light is distributed through the enclosure by specular reflection of the shallow angle light.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a top schematic view of a microwave cavity with a reflector adapted with slots to provide air flow channels.

FIG. 2 is a cross sectional view of the microwave cavity and reflector from FIG. 1.

FIG. 3 is a partial cross sectional view of a sealed microwave discharge lamp system including a cross sectional view of the cavity and reflector taken along the axis of cavity.

FIG. 4 is a partial cross sectional view of a second example of a sealed microwave discharge lamp system with forced air cooling.

FIG. 5 is a top, schematic diagram of a third example of a sealed microwave cavity with another reflector configuration including air flow channels.

FIG. 6 is a cross sectional view of the microwave cavity and reflector from the third example.

FIG. 7 is a partial cross sectional view of the cavity and reflector taken along the axis of the cavity, together with selected lamp components from the third example.

FIG. 8 is a partial cross sectional view of a fourth example of a sealed microwave lamp system with forced air cooling.

FIG. 9 is a partial cross sectional view of a fifth example of a sealed microwave lamp system with forced air cooling.

FIG. 10 is a schematic representation of a light distribution system according to the present invention, before assembly.

FIG. 11 is a schematic representation of a light distribution system according to the present invention, during assembly.

FIG. 12 is a schematic representation of a sealed light distribution system according to the present invention.

FIG. 13 is a schematic view of a first plastic sheet in a preliminary stage of preparation for forming the light pipe described in the '815 publication.

FIG. 14 is a schematic view of a second plastic sheet in a preliminary stage of preparation for forming the light pipe described in the '815 publication.

FIG. 15 is a cross sectional view of the assembled light pipe.

FIG. 16 is a cross sectional view of an alternative construction for the assembled light pipe.

FIG. 17 is a schematic view of a plastic sheet in a preliminary stage of preparation for forming the spiral wound light pipe according to the present invention.

FIG. 18 is a cross sectional schematic view of one example of an assembled light pipe in accordance with the present invention.

FIG. 19 is a schematic view of a plastic sheet in a preliminary stage of preparation for forming another spiral wound light pipe according to the present invention.

FIG. 20 is a cross sectional schematic view of another example of an assembled light pipe in accordance with the present invention.

FIG. 21 is a cross sectional schematic view of another example of an assembled light pipe in accordance with the present invention.

FIG. 22 is a cross sectional schematic view of another example of an assembled light pipe in accordance with the present invention.

FIG. 23 is a perspective view of a box shaped light fixture according to the present invention.

FIG. 24 is a perspective view of a disc shaped light fixture according to the present invention.

FIG. 25 is a schematic cross sectional view of a first example of a light fixture of the present invention.

FIG. 26 is a schematic cross sectional view of a second example of a light fixture of the present invention.

FIG. 27 is a schematic cross sectional view of a third example of a light fixture of the present invention.

FIG. 28 is a schematic cross sectional view of a fourth example of a light fixture of the present invention.

FIG. 29 is a perspective, cut-away view of a fifth example of a light fixture of the present invention.

FIG. 30 is a fragmented cross sectional diagram of a sixth example of a light fixture including ray tracing lines.

FIG. 31 is a fragmented cross sectional diagram of a seventh example of a light fixture including ray tracing lines.

FIGS. 32-38 are further examples of light fixtures of the present invention.

### DESCRIPTION

In the following description, for purposes of explanation and not limitation, specific details are set forth such as particular structures, interfaces, techniques, etc. in order to provide a thorough understanding of the present invention. However, it will be apparent to those skilled in the art having the benefit of the present disclosure that the invention may be practiced in other embodiments that depart from these specific details. In certain instances, descriptions of well known devices and methods are omitted so as not to obscure the description of the present invention with unnecessary detail.

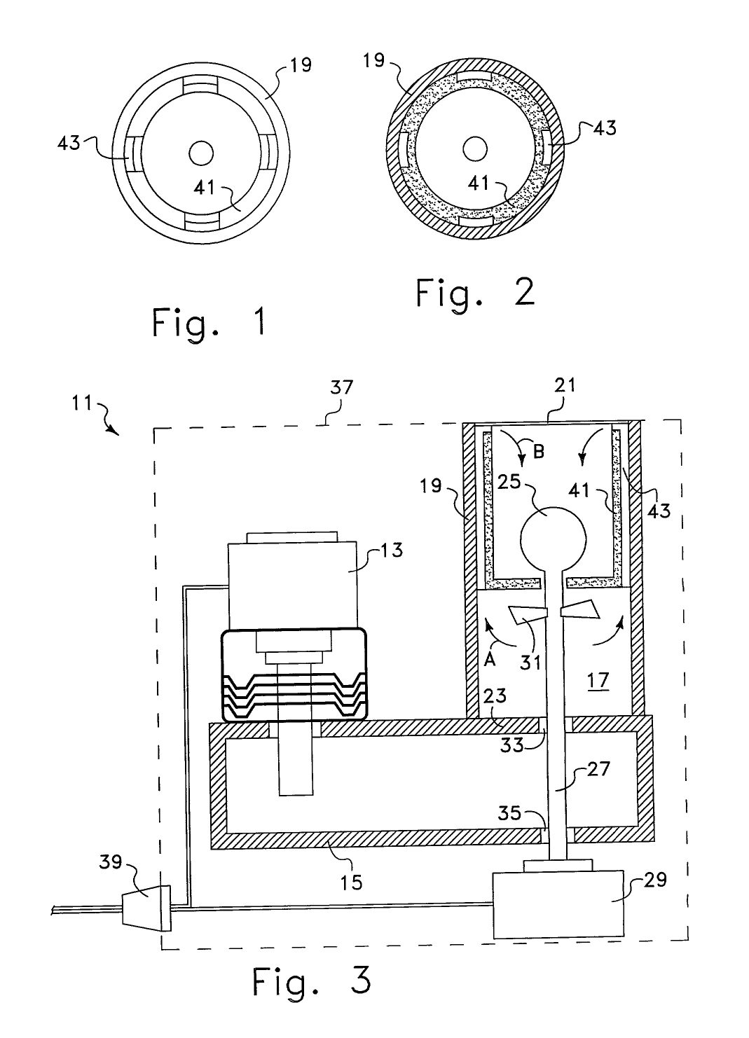

With reference to FIGS. 1-3, a sealed microwave discharge lamp 11 includes a magnetron 13 which provides microwave energy via a waveguide 15 to a microwave cavity 17. A conductive enclosure 19 together with a lid 21 and a surface 23 of the waveguide 15 define the microwave cavity 17.

As illustrated, the enclosure 19 comprises a metal cylindrical tube having a diameter and length selected to support a desired microwave mode within the cavity 17. The lid 21 may have any of a variety of constructions as described in the '651 publication. In a preferred construction, the lid 21 includes a conductive mesh utilized together with a light transmissive quartz disc. The mesh contains the microwave energy within the cavity while allowing light to escape. The quartz disc seals the cavity 17 from the outside environment. Further details regarding the cavity and/or lid may be had by reference to the '651 publication.

The sealed microwave lamp 11 includes a bulb 25 which encloses a plasma forming fill which emits light when excited by microwave energy. The bulb 25 is mounted to one end of a dielectric stem 27 which supports the bulb 25 at a desired positioned within the cavity 17. The other end of the stem 27 is connected to a motor 29 which rotates the bulb 25 during lamp operation. In the illustrated example, fan blades 31 are mounted on the stem 27 to create circulation of the air sealed within the cavity volume when the bulb 25 is rotated. Other suitable structures which may be mounted to the stem to create air circulation include, for example, fins, a blower, or a squirrel cage. Alternatively, such structures may be attached to the bulb 25 itself as described in U.S. Statutory Invention Registration No. H1,876.

In FIG. 3, the stem 27 passes through a slot 33 and a hole 35 in the waveguide 15. The slot 33 is a coupling slot for coupling microwave energy from the waveguide into the cavity 17. A ball bearing or sleeve (not illustrated) may be disposed around the stem 27 in the region of the hole 35 to inhibit contaminants from entering the otherwise sealed volume of the waveguide 15 and cavity 17. Other appropriate gaskets, seals, and/or sealants may be used at the various interfaces of the magnetron 13, waveguide 15, enclosure 19, and lid 21 to maintain the sealed environment. Alternatively or additionally, any or all of the lamp system components may be contained within a sealed enclosure 37, shown schematically with a dashed line. Power is provided to the components inside the sealed enclosure 37 (e.g. the motor 29 and the magnetron 13) by a sealed feedthrough 39.

In accordance with the present invention, the sealed microwave lamp 11 further includes at least one air flow channel to circulate air past the bulb and through heat exchanging surfaces. In the illustrated example, a reflector 41 is substantially cup shaped with an open end and a closed end (except for a hole for the stem 27) and defines a plurality of slots 43 around the outer perimeter of the reflector 41, which together with the inside wall of the enclosure 19 provide the air flow channels for the lamp 11. The reflector 41 is made from high reflectivity dielectric material (e.g. alumina) as described in more detail in the '651 publication. The reflector 41 is disposed inside the microwave cavity 17 and around the bulb 25 to increase the brightness and directivity of light from the lamp 11. In the illustrated example, an outside wall of the reflector 41 is in contact with an inside wall of the metal tube 19, thereby defining an air flow circulation path through the slots 43. Air is drawn over the bulb 25 with some of the heat from the bulb 25 being transferred to the air. The hot air A is circulated through the channels where some heat from the air is transferred to the tube 19. Relatively cooler air B exits the channels 43 where it is re-circulated past the bulb 25. The air flow continually circulates past the bulb 25 and through the channels, thereby providing a heat exchange which can transfer heat from the bulb 25 to the enclosure 19. If necessary or desirable, the enclosure 19 may be thermally connected to an additional external heatsink.

Advantageously, the lamp 11 may be operated at higher power levels and higher light output as compared to a lamp with no forced air cooling. Another advantage is that the rate of cooling may be controlled in accordance with the rate of rotation of the bulb. For example, the rate of rotation may be increased as the input power is increased to provide greater cooling at higher power levels. Suitable microprocessor based or other control circuits may be adapted to control the bulb temperature by varying the rotation speed of the motor. Other parameters corresponding to bulb temperature (e.g. light output and spectral characteristics) may likewise be controlled.

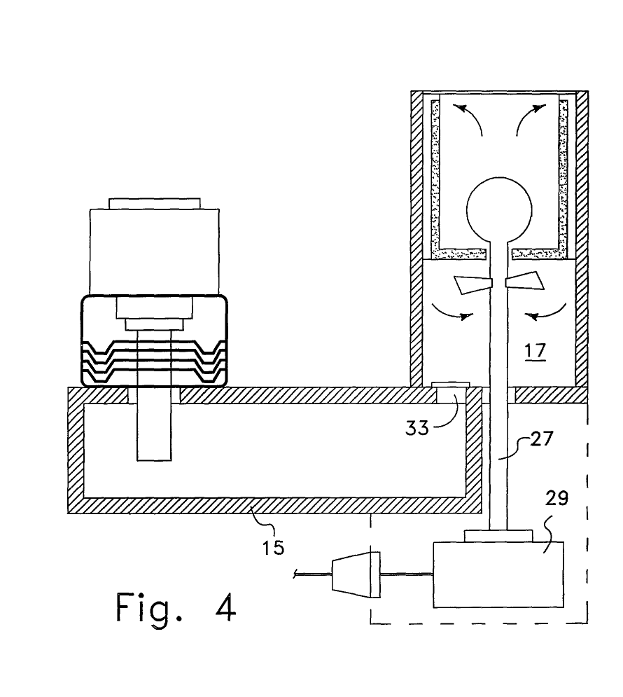

With reference to FIG. 4, the second example of the invention is similar to the first example, except that the stem 27 does not pass through the waveguide 15 (or the coupling slot 33) and the air flow path is reversed. The stem 27 passes through a hole 45 (which may be sealed with a bearing or a sleeve) in a conductive extension 47 of the waveguide housing. The coupling slot 33 may be covered or fitted with a suitably sized piece of low microwave loss dielectric material 49 to isolate the air flow circulation within the microwave cavity 17. In the second example, an additional sealed enclosure 51 contains only the motor 29, thereby providing extra protection from contamination entering the cavity 17 through the hole 45.

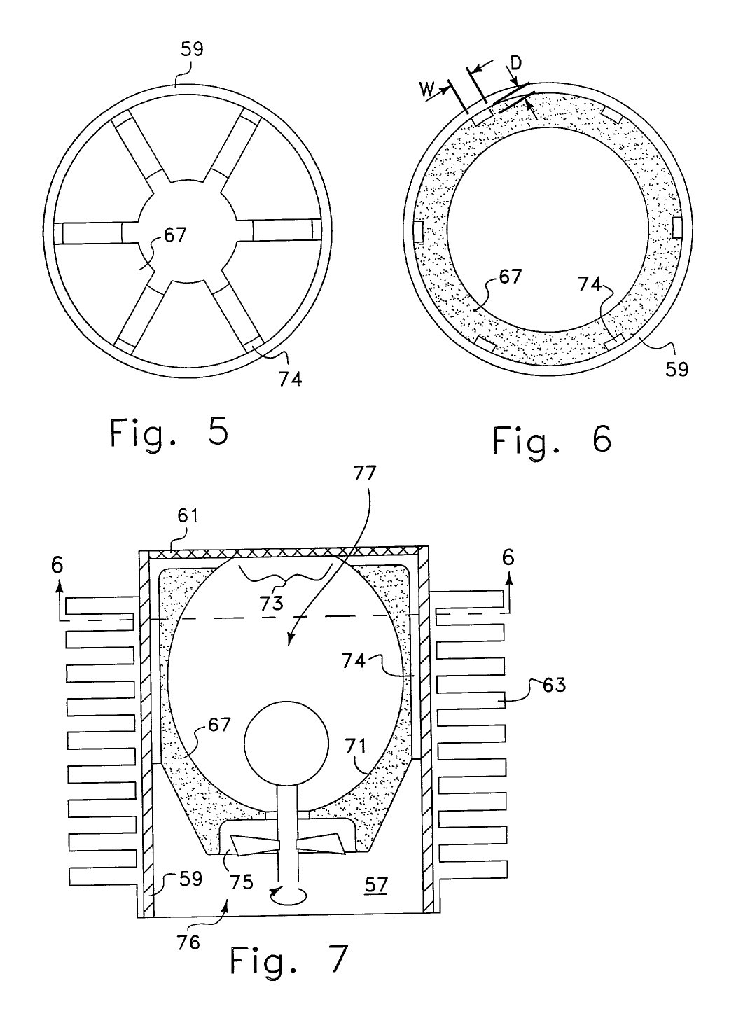

With reference to FIGS. 5-7, a third example of a sealed microwave cavity includes a conductive enclosure 59 which together with a lid 61 and a waveguide housing (not shown) define a microwave cavity 57. The enclosure 59 is connected to an additional external heatsink 63 for additional heat exchanging capability. In the illustrated example, a reflector 67 has a complex geometry defining an inner reflecting surface 71 except the in the region of a light emitting aperture 73. An outside diameter of the reflector 67 is adapted fit tightly with an inside diameter of the enclosure 59. For example, the two parts 59 and 67 may be assembled by heating the metal enclosure 59 so that it expands slightly, positioning the reflector 67 inside the enclosure 59, and cooling the enclosure 59 so that it fits snugly around the reflector 67. The reflector 67 defines a plurality of slots 74 which together with the inside wall of the enclosure 59 provide air flow channels for cooling the bulb. Preferably, the aspect ration of the width W and depth D of the slots 74 is greater than one (W/D>1) to form a heat exchanger with the walls of the enclosure 59 and the heatsink 63. The reflector 67 further defines a shroud area 75 at its closed end for the fan blades. The shroud and fan are designed to produce a pressure differential between the lower part 76 of the cavity and the volume 77 containing the bulb.

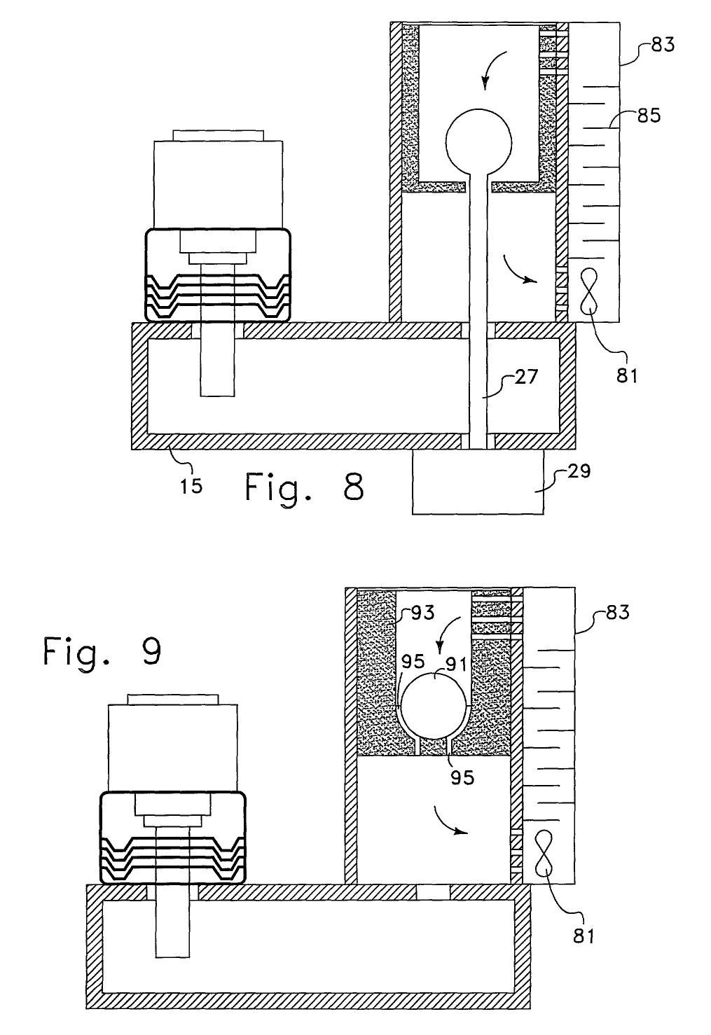

With reference to FIG. 8, the fourth example utilizes a separate fan 81 to provide the air circulation instead of structures on the stem 27. In FIG. 8, the motor 29 is mounted directly against the waveguide 15 housing, thus inhibiting contaminants from entering the waveguide or cavity volume through the hole for the stem 27 (with appropriate gaskets or seals). The illustrated example further includes an air duct 83 for directing the air flow path from the bottom of the microwave cavity to the top of the cavity. The duct may include internal baffles 85 to increase the amount of heat exchanged.

With reference to FIG. 9, the fifth example of a sealed microwave discharge lamp includes an electrodeless bulb 91 containing a fill which does not require rotation for a stable plasma discharge when excited by microwave energy. Accordingly, the stem and motor are omitted. The bulb 91 is supported by a reflector 93 which is adapted to secure the bulb 91 in a desired position in the microwave cavity. The reflector 93 defines a plurality of channels 95 which allow air to flow around the bulb 91. The fan 81 and duct 83 are as described above in connection with FIG. 8.

Sealed Light Pipe

In many light pipe applications, it is desirable to keep dust and other contaminants out of the light distribution system. Rigid joints and seals present various problems. For example, relatively precise alignment is required between the lamp reflector and the light pipe. Rigid joints are subject to stress because the pipe material is subject to expansion and contraction. This problem is accentuated in outdoor settings where the light pipe is subject to wide temperature variations. Movement of the pipe due to wind or vibration also causes problems with rigid joints or seals.

According to a present aspect of the invention, a flexible seal is provided which is inexpensive, easy to install, and tolerant of minor mis-alignments. The seal is also tolerant of a small amount of expansion, contraction, movement, and vibration.

With reference to FIGS. 10-12, a light distribution system includes a hollow-core light pipe 109 having an annular ring 103 of elastomeric material secured to an open end of the light pipe 109. The system further includes a lamp 105 with a reflector 107. The ring 103 is adapted with an opening which is slightly smaller than a peripheral boundary of the reflector 107. For example, where the reflector 107 has a circular output opening, the ring has a central hole with a diameter slightly smaller than the outer diameter of the reflector.

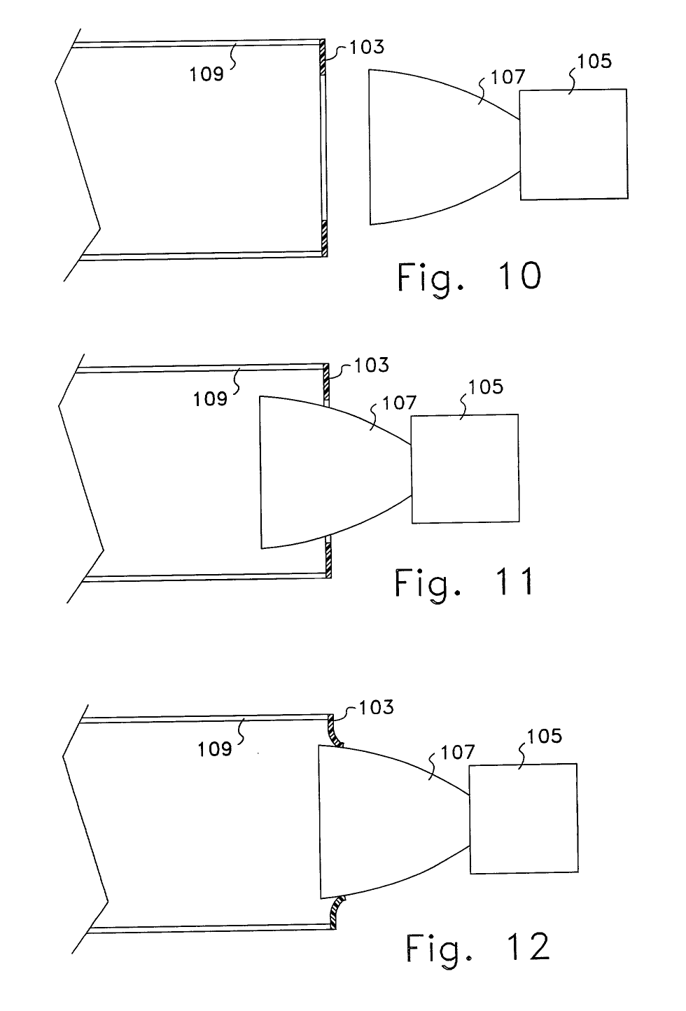

The reflector 107 is pushed through the ring 103 until the reflector 107 is clear of the ring 103 (see FIG. 11). The ring 103 stretches to receive the reflector 107. The reflector 107 is then withdrawn until the ring 103 makes a seal around the outside of the reflector 107 (see FIG. 12). A bead of high temperature caulk or gasket material may be added to the ring to improve its sealing qualities. Preferably, the ring 103 is made from a high temperature material which maintains its resiliency for a long period of time, even under outdoor conditions.

Spiral Multilayer Light Pipe

A present aspect of the invention pertains to light pipes utilized for distribution of light from a light source. More particularly, the present aspect of the invention relates to a cost effective, efficient light pipe constructed from simple plastic sheet materials.

Light pipes are conduits which distribute light from a light source over a large area. Certain light pipes are made from optical material configured with surface to air interfaces providing total internal reflection (TIR). An example of such light pipes are described in U.S. Pat. No, 4,260,220, entitled “Prism Light Guide having Surface which are in Octature,” by Lorne A. Whitehead. The Minnesota Mining and Manufacturing Company (3M) produces a commercially available optical material called Optical Lighting Film (OLF) which is useful for constructing light pipes. An example of OLF is described in U.S. Pat. No. 4,906,070.

One problem with conventional light pipes is that the optical material consists of micro-replicated prisms, perforated silvered plastic, or complex dielectric coatings on transparent surfaces. These approaches are relatively complex and costly.

Another problem with conventional light pipes is that some of the above-mentioned materials are also relatively inefficient in terms of distributing light from the source into the environment to be illuminated. For example, optical materials providing TIR are designed to contain the light within the material. In order to utilize such material for distribution of light, irregularities are introduced into the material to allow light to escape. The process of light leakage is difficult to control and the light output of the distributed light over a large area varies considerably.

A simpler, cost effective light pipe made from plastic sheet material is described in PCT Publication No. WO 00/43815. The light pipe utilizes a combination of diffuse and specular surfaces to efficiently distribute light.

It is an object of the present aspect of the invention to provide a light pipe having a simple structure which efficiently distributes light over a large area.

One aspect of the invention is achieved by a light pipe comprising a plurality of layers formed from a single spiral wound plastic sheet.

The foregoing objects, features, and advantages of the invention are achieved individually and in combination. The invention should not be construed as requiring two or more of the foregoing features unless expressly recited in the claims.

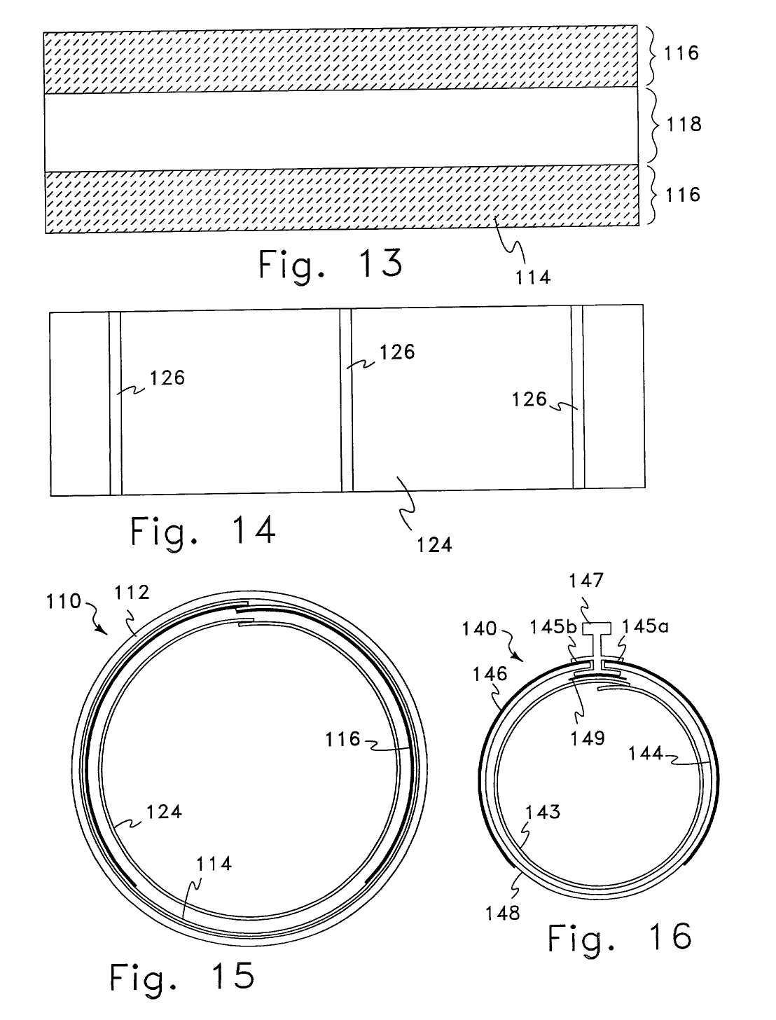

With reference to FIGS. 13-15, an example of a light pipe described in the '815 publication is constructed as follows. A 2.4 m (8 feet) section of light pipe 110 includes a pre-formed clear plastic rigid jacket 112 having an approximately 15 cm (6 inch) outer diameter. An approximately 47 cm (18.4 inch) wide by 2.4 m (8 feet) long plastic polycarbonate sheet 114 (0.5 mm/0.02 inch thick) having a gloss finish on one side and a matte finish on the other side is prepared with several slightly overlapping strips of white vinyl tape running lengthwise down the sheet to provide an approximately 18 cm (7 inch) wide strip 116 of reflecting material on each side of the gloss finish side of the sheet. This leaves an approximately 11 cm (4.8 inch) transparent strip 118 down the middle of the sheet 114. The sheet 114 is rolled with the tape 116 on the interior and held to a diameter of less than 15 cm (6 inch) and inserted in the rigid jacket 112. The sheet 114 is then released and unrolls against the outer jacket 112. The two strips 116 abut each other or overlap slightly to provide an approximately 270° reflecting surface and a 90° light transmissive window defined by the transparent strip 118.

Another plastic sheet 124 of approximately 46 cm (18.1 inch) wide by 2.4 m (8 feet) long plastic polycarbonate sheet (0.5 mm/0.02 inch thick) having a gloss finish on both sides is prepared with strips of neoprene 126 across the width of the sheet 124 spaced every 45 cm (18 inch) or so. The neoprene 126 is approximately 1.5 mm (1/16th inch) thick and is glued to the sheet with translucent RTV 108 silicone. After drying, the sheet 124 is rolled with the neoprene 126 on the outside and held to a diameter of less than 15 cm (6 inch). The sheet 124 is then inserted in the pipe section 110 and released to unroll against the earlier inserted sheet 114. The neoprene 126 provides an air gap between the two layers of plastic sheet 114, 124.

Three such sections 110 are assembled and connected together to form a 24 foot long light pipe. The rigid jackets 112 abut and are taped at the seams. A small length of the inner layers 114, 124 may extend beyond the ends of the rigid jacket 112 and may be interleaved with the next section's inner layers. The light pipe is suspended from a ceiling and illuminated with a Cyberlight® spotlight, commercially available from High End Systems, Austin, Texas. The spotlight provides approximately 7000-8500 lumens of light in a collimated beam which may be adjusted from between about 15° to 28° full beam angle. A reflective end cap is mounted on the end of the light pipe opposite the spotlight. The reflective portion of the end cap is tilted about 10° from vertical.

With reference to FIG. 16, an example of a second construction from the '815 publication is as follows. A six foot section of light pipe 140 includes a rolled outer sleeve having an approximately 15 cm (6 inch) outer diameter. An approximately 47 cm (18.4 inch) wide by 1.8 m (6 feet) long plastic polycarbonate sheet 144 (0.5 mm/0.02 inch thick) having a gloss finish on one side and a matte finish on the other side is prepared with a strip of highly reflective Mylar running lengthwise down the sheet to provide an approximately 18 cm (7 inch) wide strip 46 of reflecting material on each side of the matte finish side of the sheet. For example, several overlapping strips of transparent double sided tape may be utilized to secure the Mylar to the sheet 144. This leaves an approximately 11 cm (4.8 inch) transparent strip 48 down the middle of the sheet 144. One side of the sheet 144 is inserted in a channel 145a of an extruded mounting device 147 with the strip 146 on the outside. The sheet 144 is then taped or otherwise suitably secured to one side of the mounting device. The sheet 144 is then rolled with the strip 146 on the exterior and the free edge of the sheet 144 is inserted in the open channel 145b. The sheet 144 is then taped or otherwise suitably secured to the other side of the mounting device 147, thereby forming the outer sleeve. The two strips 146 provide an approximately 270° reflecting surface and a 90° light transmissive window defined by the transparent strip 148. Depending on the material used for the mounting device, a strip of reflective material 149 may be disposed on an interior surface of the mounting device 147 to provide desired light reflecting characteristics (e.g. some combination of diffuse and/or specular reflection).

Another plastic sheet 143 of approximately 46 cm (18.1 inch) wide by 1.8 m (6 feet) long plastic polycarbonate sheet (0.5 mm/0.02 inch thick) having a gloss finish on one side and a matte finish on the other side is prepared with 3 strips of 3M transparent foam tape across the width of the sheet on the matte finish side. One strip is approximately centered and the other two strips are spaced about 15 cm (6 inch) from each end. The tape is approximately 1.5 mm (1/16th inch) thick. The sheet 143 is rolled with the tape on the outside and held to a diameter of less than 15 cm (6 inch). For example, one or both sides of the rolled sheet 143 may be secured with masking tape. The sheet 143 is then inserted in the pipe section 140 and released (e.g. the masking tape is removed) to unroll against the outer sheet 144. The tape provides an air gap between the two layers of plastic sheet 143, 144.

Five such sections 140 are assembled and connected together to form a 30 foot long light pipe. Two additional layers of diffusing material, one about 120 cm (4 feet) long and the other about 90 cm (3 feet) long, are positioned in the first section near the light source to reduce the appearance of a bright spot. The outer sleeves abut and may be taped or otherwise coupled together at the seams. A small length of the inner layers 143 may extend beyond the ends of the outer sleeves 144 and may be interleaved with the next section's inner layers. The light pipe is suspended from a ceiling and illuminated with a high intensity metal halide lamp disposed in a parabolic reflector. A suitable lamp is commercially available from Osram/Sylvania of Danvers, Mass. as model no. VIP R 400/32. The lamp provides approximately 20,000 lumens of light in a focused beam having an approximately 12° full beam angle. A reflective end cap is mounted on the end of the light pipe opposite the spotlight. A concave reflector is positioned in the end cap to reduce the appearance of a bright spot at the end of the light pipe distal to the source.

Another example of a suitable light source is an ILC Cermax 300 compact xenon lamp with an integral reflector providing a beam spread of just over 14° half angle. Other suitable light sources include the sealed microwave lamp described above and the light sources described in PCT Publication Nos. WO 99/36940, WO 00/70651, and WO 01/03161, together with suitable optics for providing a desired beam angle.

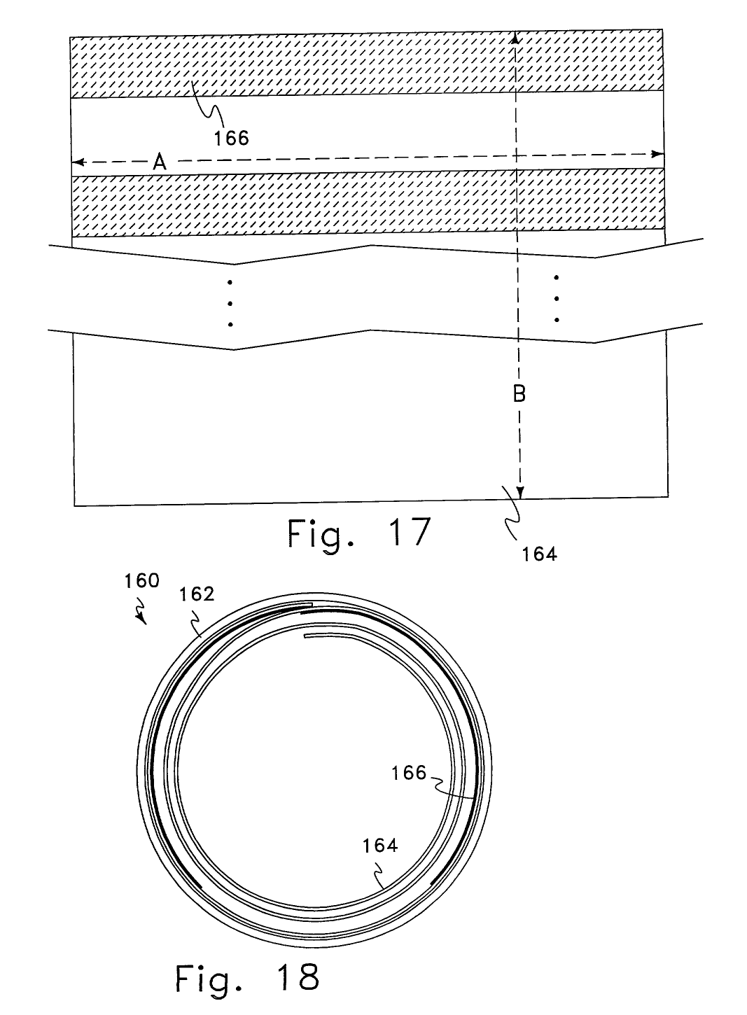

A first example of a spiral wound light pipe in accordance with a present aspect of the invention is described with reference to FIGS. 17-18. A plastic sheet 164 has a first dimension A which corresponds to a length of a light pipe section and a second dimension B which corresponds to some multiple C of the light pipe diameter where C>1.0 and generally C>2.0. The plastic sheet 164 optionally includes strips 166 of white vinyl tape, reflective material (e.g. Mylar), or other material possessing a desired optical property. Acrylic is a preferred material for the plastic sheet 164 (e.g. 0.5 mm acrylic from Cyro Industries).

In FIG. 18, a light pipe 160 includes an outer conduit 162 with the sheet 164 being spiral wound inside the conduit 162 and supported by the conduit 162. For example, the sheet 164 is rolled to an outside diameter which is less than an inside diameter of the conduit 162, inserted inside the conduit 162, and allowed to unroll against the wall of the conduit 162. If necessary or desirable, spacers such as transparent foam tape may be utilized to maintain an air gap between layers of the spiral wound sheet 164. Alternatively, the sheet 164 may include ribs or embossments to maintain a desired spacing between layers. Several sections of the light pipe 160 may be axially aligned to provide a longer light distribution system.

The light pipe described in the '815 publication utilizes several concentric sheets of plastic to provide multiple layers. As compared to the light pipes of the '815 publication, the spiral wound light pipe of the present invention utilizes simpler construction to provide the multiple layers.

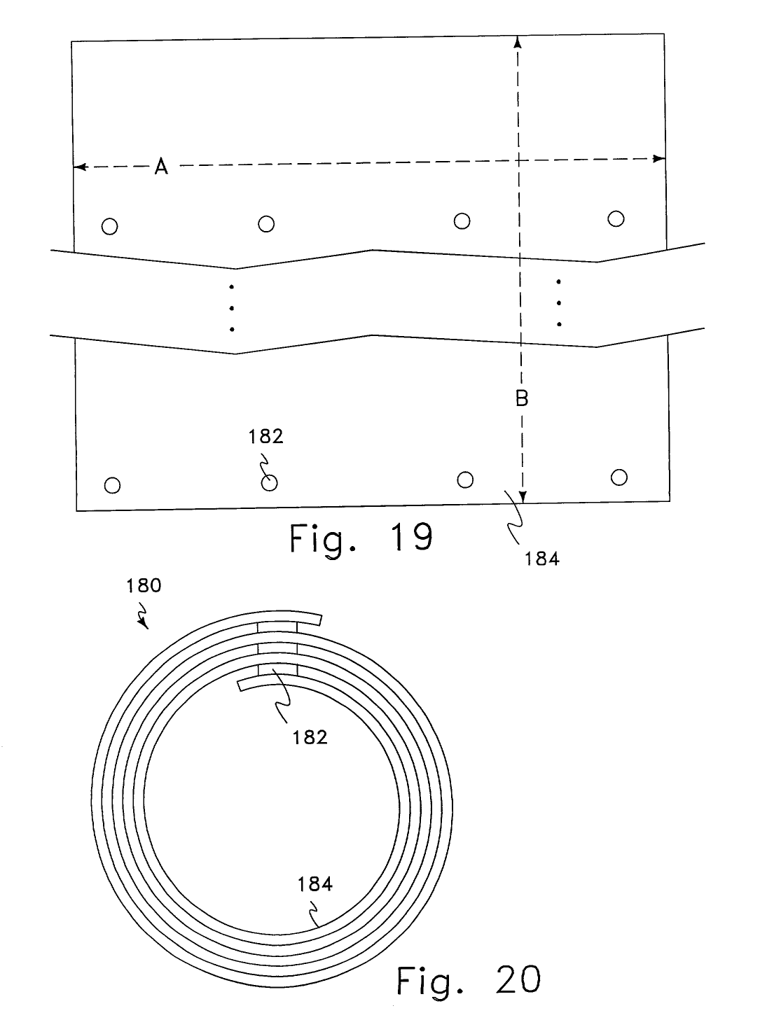

Certain spacer elements can have a negative impact on the distribution of the light. With reference to FIGS. 19-20, a light pipe 180 includes a spiral wound plastic sheet 184 wherein the layers are separated only by small disc spacers 182 positioned near the top of the light pipe 180. Several disc spacers 182 are provided intermittently (e.g. every 2 feet) along the length A of the plastic sheet. Several rows of the disc spacers are provided in accordance with the diameter of the spiral such that the rows of disc spacers become aligned at the top of the light pipe as the sheet is wound into its spiral form. Air gaps between the layers are provided without intercepting a significant amount of light.

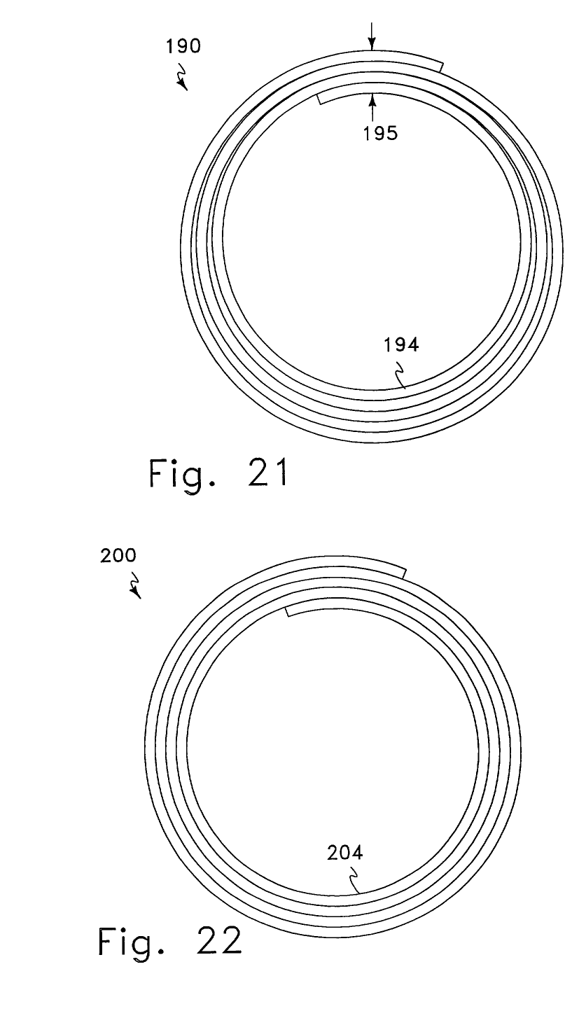

With reference to FIG. 21, a light pipe 190 includes a spiral wound plastic sheet 194 wherein the layers are substantially self supporting and clamped at a single point 195 on the light pipe 190 (e.g. near the top of the light pipe). Air gaps between the layers are provided (except at the point of contact) without spacer elements.

Moreover, it has been found that many plastic materials have a surface roughness which intrinsically provides embossments which are sufficient to maintain a suitable air gap without further spacer elements. With reference to FIG. 22, a light pipe 200 includes a spiral wound plastic sheet 204 with no identifiable spacer elements or air gaps visible to the naked eye. The air gaps between layers are provided by the intrinsic surface roughness of the material.

Light Distribution System

The present aspect of the invention relates generally to light distribution systems. The present invention relates more specifically to a novel light fixture for distributing light from a high brightness source.

High brightness lamps provide a high concentration of light emanating from a relatively small area. For general illumination applications, the light from such lamps must be distributed over the area to be illuminated.

Examples of such high brightness lamps include the microwave sulfur lamp described in U.S. Pat. No. 5,404,076, the solid state aperture lamp described in U.S. Pat. No. 6,137,237, and the sealed microwave lamp described in PCT Publication No. WO 00/70651, all of which are electrodeless lamps. Lamps with internal electrodes such as metal halide arc lamps may also be considered high brightness lamps.

Examples of light distribution systems include reflectors surrounding the light source to direct the light output into conduits referred to as light pipes. Certain light pipes utilize prismatic material to transport the light down the pipe with total internal reflection. Such light pipes are described in U.S. Pat. Nos., 4,260,220 and 4,805,984. Light leaks out of the prismatic material in a controlled manner to provide relatively uniform illumination. Recently, a new type of light pipe has been invented which utilize simple plastic sheet material to transport the light down the pipe with shallow angle Fresnel reflection. Because the shallow angle light requires very few reflections down the pipe, the light distribution efficiency is high. Such light pipes are described in PCT Publication WO 00/43815.

An object of the present invention is to provide novel light fixtures for distributing light from a high brightness light source.

According to one aspect of the invention, a light fixture includes a box shaped or disc shaped enclosure with one or more walls formed from one or more layers of plastic sheet material. The light fixture further includes a reflector configured to transform higher angle light from a high brightness light source into shallow angle light. The shallow angle light reflected from the plastic sheet material is efficiently distributed from the enclosure.

The foregoing and other objects, aspects, advantages, and/or features of the invention described herein are achieved individually and in combination. The invention should not be construed as requiring two or more of such features unless expressly recited in a particular claim.

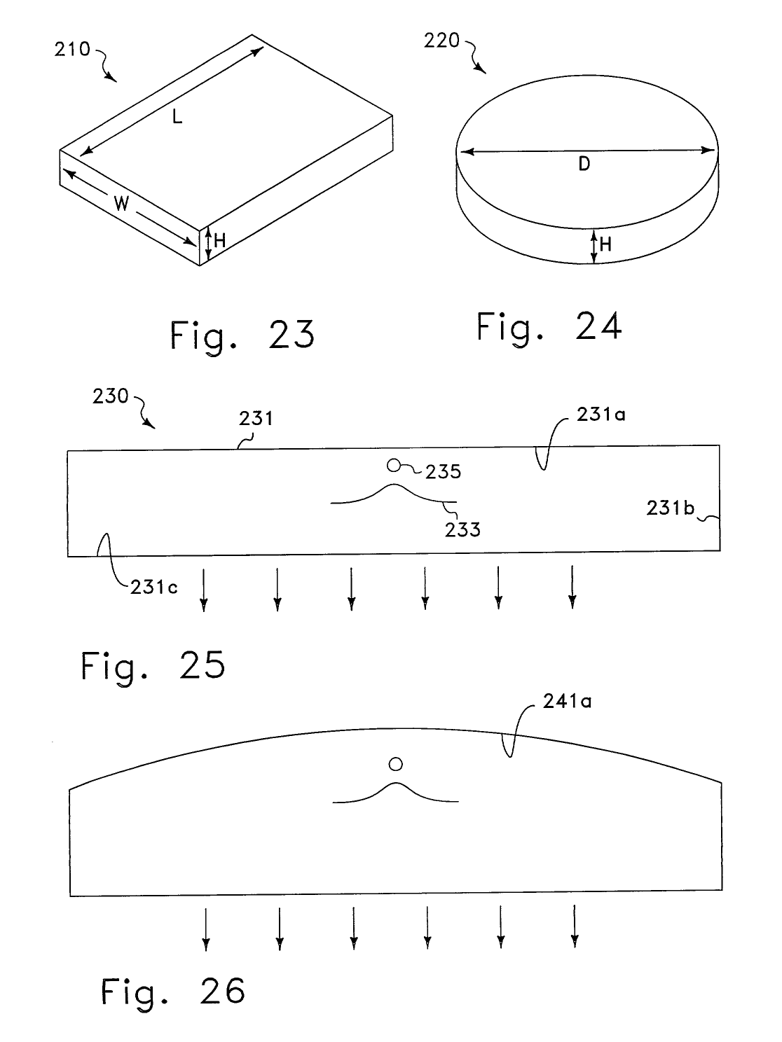

With reference to FIG. 23, a box shaped light fixture 210 has a length L, a width W, and a height H. The aspect ratio of the length to the height is generally at least 10:1 and typically is 20:1 or more. For a high power lamp, such as a 1000W microwave powered sulfur lamp, the height is generally six inches or more and is preferably about 10 to 18 inches. For a lower power lamp (e.g. less than 200W), the height is generally between about 2 and 4 inches and the fixture may have the general form factor of a standard 2″×4″ florescent light fixture. A single light source may illuminate the entire structure or several light source may be used, depending on the application.

With reference to FIG. 24, a disc shaped light fixture 220 has a diameter D and a height H. The aspect ratio of the diameter to the height is generally at least 10:1 and typically is 20:1 or more. For a high power lamp, such as a 1000W microwave powered sulfur lamp, the height is generally six inches or more and is preferably about 10 to 18 inches. For a lower power lamp (e.g. less than 200W), the height is generally between about 2 and 4 inches. A single light source may illuminate the entire structure or several light source may be used, depending on the application.

With reference to FIGS. 25 and 26, a light fixture 230 includes an enclosure 231. The fixture 230 may be ceiling mounted or suspended. Within the enclosure 231, a reflector 233 is used to transform high angle light to shallow angle light (with respect to a bottom wall 231c of the enclosure). A light source 235 is shown as being disposed inside the enclosure 231, but may alternatively be disposed outside the enclosure so long as light from the light source 235 is directed to the reflector 233. The light source 235 itself may include a reflector to direct light inside the enclosure 231 and towards the reflector 233. The enclosure 231 has a top wall 231a, side walls 231b, and a bottom wall 231c. The top wall 231a is specularly reflective with respect to shallow angle light, but may be diffusely reflective for higher angle light to direct some light out of the light fixture 230. Also, the top wall 231a may be partially light transmissive for situations where the fixture is not mounted directly to the ceiling. As shown in FIG. 26, the top wall 231a need not be flat. The side walls 231b may be either reflective or transmissive or some combination thereof. The bottom wall 231c employs the principles of light distribution from the above mentioned '815 publication. Specifically, the bottom wall 231c is made from one or more sheets of plastic configured to provide a desired amount of specular reflection for a given angle of incidence of light. Depending on the size of the fixture, a support structure may be used to support the plastic sheet(s). For a given output distribution of the light source 235, the size and shape of the enclosure 231, the design of reflector 233, and the materials for the enclosure 31 are selected to uniformly emit light from the fixture 230.

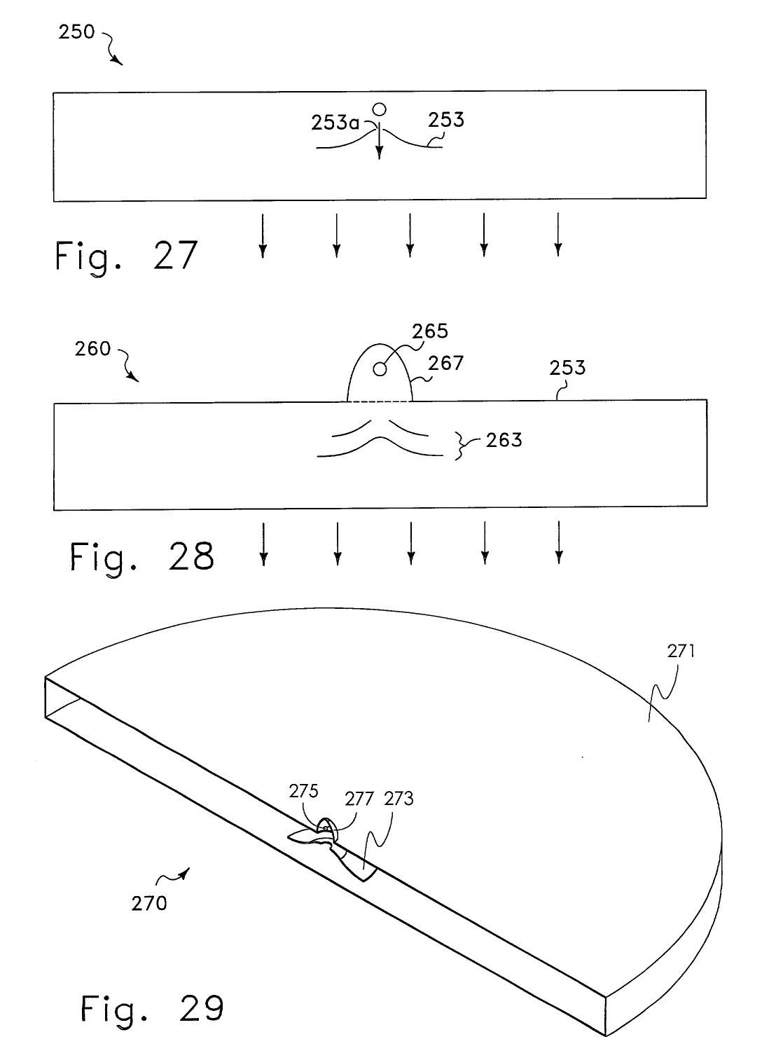

With reference to FIG. 27, the reflector 253 may include one or more apertures or slots 253a for directly emitting light through the fixture 250. With reference to FIG. 28, the light source 265 may be positioned outside of the enclosure 261 with a reflector 267 positioned around the light source 265 for directing light into the enclosure 261. The fixture 260 may include a plurality of reflectors 263.

With reference to FIG. 29, a light fixture 270 includes an enclosure 271 with a reflector 273 positioned centrally within the enclosure 271. A light source 275 is positioned just outside of the enclosure 271 with a reflector 277 disposed around the light source 275 for directing light into the enclosure 271 and towards the reflector 273.

With reference to FIG. 30, a particular reflector 283 is illustrated together with ray tracing lines which show how the reflector 283 transforms higher angle into shallower angle light for distribution through the fixture.

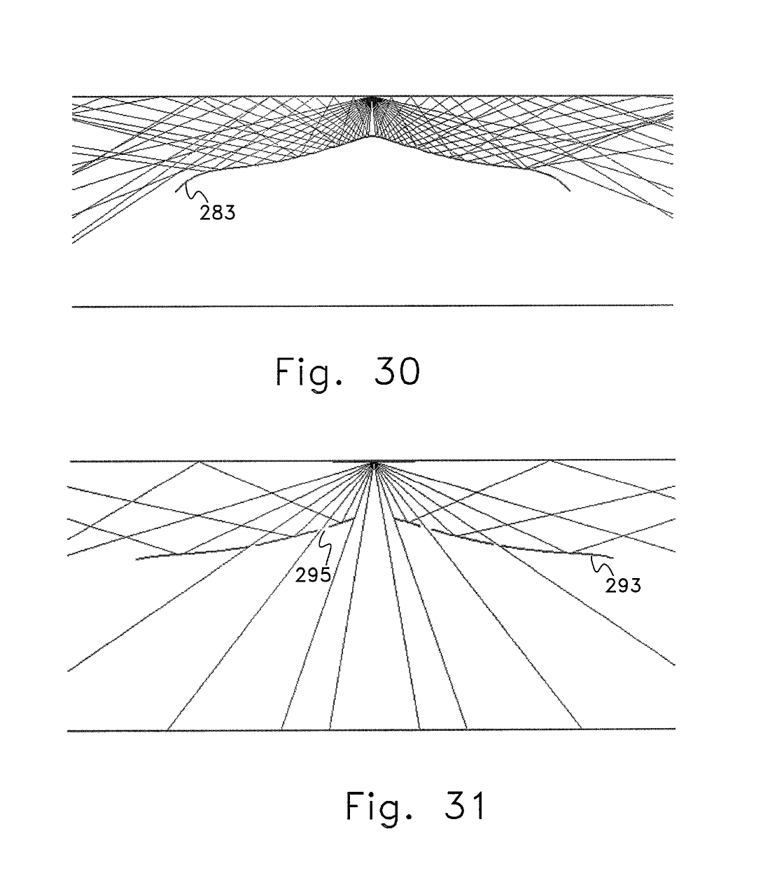

With reference to FIG. 31, a particular reflector 293 is illustrated which includes several openings 295. Ray tracing lines show the transformation of the light angles by the reflector 293 and also the direct emission of light through the openings 295.

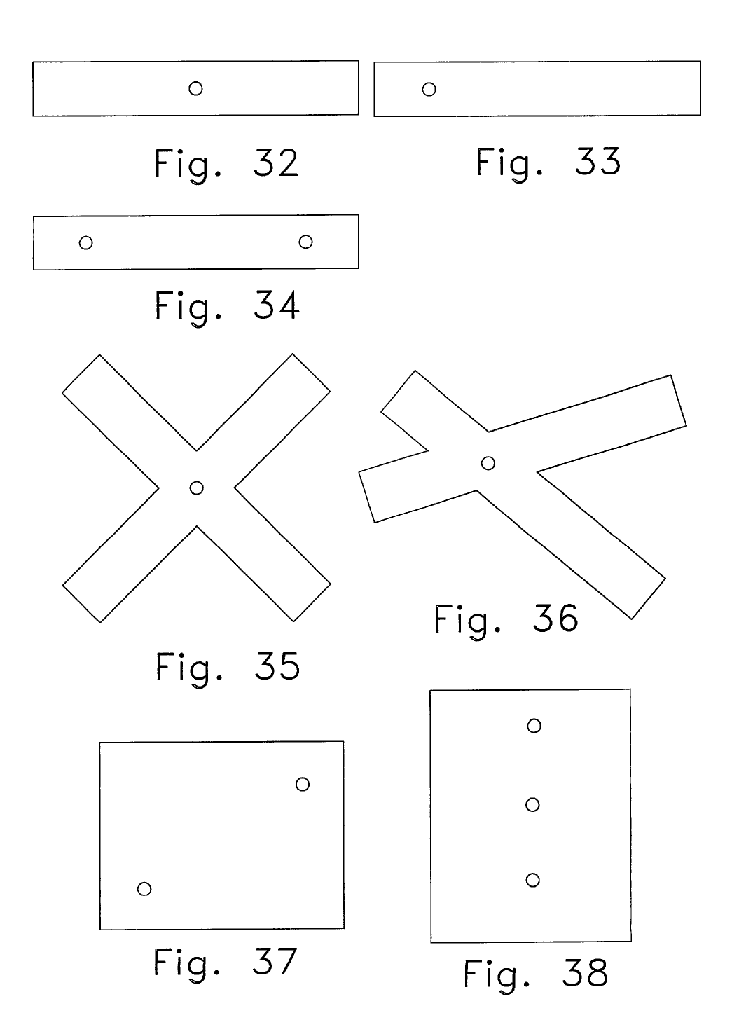

With reference to FIGS. 32-38, several top, schematic views for alternative fixture shapes are shown. The circles represent positions of light sources on or in the fixtures.

While the invention has been described in connection with what is presently considered to be the preferred embodiments, it is to be understood that the invention is not limited to the disclosed embodiments, but on the contrary, is intended to cover various modifications and equivalent arrangements included within the spirit and scope of the invention.

What is claimed is:

1. An electrodeless microwave discharge lamp, comprising:
a substantially sealed microwave cavity;
an envelope disposed within the sealed cavity, the envelope containing a fill which emits light when excited by microwave energy; and
means for circulating air inside the sealed microwave cavity.

2. The lamp as recited in claim 1, wherein the means for circulating air includes a ceramic reflector inside the cavity with defined air flow channels.

3. The lamp as recited in claim 2, wherein the means for circulating air further includes a fan for moving air through the defined air flow channels.

4. The lamp as recited in claim 3, wherein the envelope is adapted to rotate during operation and wherein the fan comprises blades mounted on the stem of the bulb inside the sealed cavity.

5. A light distribution system, comprising:
a hollow light pipe having an opening at one end; and
an annular ring of elastomeric material secured to the open end of the light pipe, the ring defining an opening adapted to receive a reflector therein.

6. The light distribution system as recited in claim 5, further including a lamp with a reflector, wherein the reflector is received in the opening of the ring and the ring forms a seal around the outside of the reflector.

7. A light distribution system, comprising:
a multi layer light conduit having at least two full layers formed by a single spiral wound plastic sheet.

8. A light distribution system, comprising:
an enclosure having at least one light emitting wall formed from one or more sheets of plastic material;
a light source positioned to deliver light into the enclosure; and
a reflector positioned to receive light from the light source to transform at least some of the light from the light source into shallow angle light relative to the light emitting wall,
wherein light is distributed through the enclosure by specular reflection of the shallow angle light.
